(19) United States
(12) Patent Application Publication
(10) Pub. No.: US 2008/0148390 A1
(43) Pub. Date: Jun. 19, 2008

(54) Secure program launch

(76) Inventors: Vincent J. Zimmer, Federal Way, WA (US); Oin Long, Shanghai (CN)

Correspondence Address: INTEL CORPORATION;c/o INTELLEVATE, LLC, P.O. BOX 52050, MINNEAPOLIS, MN, 55402, US

(21) Appl. No.: 11/639,076

(22) Filed: Dec. 14, 2006

(51) Int. Cl. H04L 9/32

(52) U.S. Cl. 726/17

(57) ABSTRACT

In an embodiment, a method is provided. The method of this embodiment provides querying a manageability engine to determine if the program is trusted based, at least in part, on an authentication list, failing launch of the program if the program is not trusted, and launching the program if the program is trusted

### FIELD

Embodiments of this invention relate to secure program launch.

### BACKGROUND

As used herein, a “program” refers to a computer file that may be executed, or launched, in a computer system to perform a function or a series of functions. Programs that are known to perform the desired function or functions may be referred to as trusted programs. In contrast, programs that are not known to perform the desired function or functions are not trusted programs, and may sometimes be malware. Malware is short for “malicious software”, such as a virus, which is designed to specifically damage or disrupt a system. One breed of viruses is a hypervirus. A hypervirus refers to malware that uses virtualization technology to launch itself prior to initialization of the operating system, making itself immune to virus detection. Virtualization refers to an ability of a system to run multiple operating systems so that the system may be perceived as multiple systems using the physical hardware and/or software resources of the single system.

One way to handle a hypervirus is to maintain a hard-coded authentication list that tracks a list of trusted programs. Using a hard-coded authentication list, any program that appears on the authentication list is assumed to be trusted, while any program that does not appear on the authentication list is assumed to be untrusted, therefore preventing a hypervirus, or any malware, from launching. However, since the list of trusted programs may grow, and/or may be changed, the manageability of maintaining the hard-coded authentication list could be an onerous task. Consequently, an effective, yet manageable way to prevent the launch of untrusted programs is needed.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a system.

FIG. 2 illustrates a system according to embodiments of the invention.

FIG. 3 illustrates a system according to an embodiment.

FIG. 4 is a flowchart that illustrates a method according to an embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

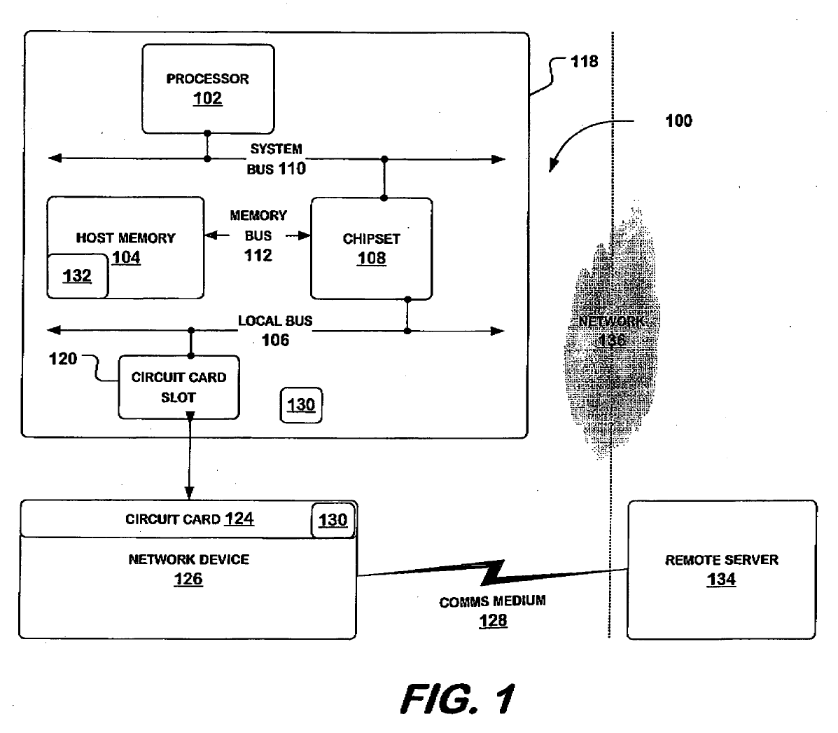

Methods described herein may be implemented in a system, such as system 100 illustrated in FIG. 1. System 100 may comprise processor 102. A “processor” as discussed herein relates to a combination of hardware and software resources for accomplishing computational tasks. For example, a processor may comprise a central processing unit (CPU) or microcontroller to execute machine-readable instructions for processing data according to a predefined instruction set. A processor may comprise a multi-core processor having a plurality of computational engines. Alternatively, a processor may comprise a computational engine that may be comprised in the multi-core processor, where an operating system may perceive the computational engine as a discrete processor with a full set of execution resources. Other possibilities exist.

System 100 may additionally comprise memory 104. Memory 104 may store machine-executable instructions 132 that are capable of being executed, and/or data capable of being accessed, operated upon, and/or manipulated. “Machine-executable” instructions as referred to herein relate to expressions which may be understood by one or more machines for performing one or more logical operations. For example, machine-executable instructions 132 may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories.

Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. Chipset 108 may comprise a host bridge/hub system that may couple processor 102, and host memory 104 to each other and to local bus 106. Chipset 108 may communicate with memory 104 via memory bus 112 and with processor 102 via system bus 110. According to an embodiment, system 100 may comprise one or more chipsets 108 including, for example, an input/output control hub (ICH), and a memory control hub (MCH), although embodiments of the invention are not limited to this.

Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

System 100 may additionally comprise one or more network devices 126 (only one shown). A “network device” as referred to herein relates to a device which may be coupled to a communication medium to transmit data to and/or receive data from other devices coupled to the communication medium, i.e., to send and receive network traffic. For example, a network device may transmit packets to and/or receive packets from devices coupled to a network 136, such as a local area network, via communication medium 128. In an embodiment, sender may comprise a client, such as system 100, and receiver may comprise, for example, a remote server 134. Such a network device 126 may communicate with other devices according to any one of several data communication formats such as, for example, communication formats according to versions of IEEE (Institute of Electrical and Electronics Engineers) Std. 802.3 (CSMA/CD Access Method, 2002 Edition); IEEE Std. 802.11 (LAN/MAN Wireless LANS, 1999 Edition), IEEE Std. 802.16 (2003 and 2004 Editions, LAN/MAN Broadband Wireless LANS), Universal Serial Bus, Firewire, asynchronous transfer mode (ATM), synchronous optical network (SONET) or synchronous digital hierarchy (SDH) standards.

In an embodiment, network device 126 may be comprised on system motherboard 118. Rather than reside on motherboard 118, network device 126 may be integrated onto chipset 108. Still alternatively, network device 126 may be comprised in a circuit card 124 (e.g., NIC or network interface card) that may be inserted into circuit card slot 120. When circuit card 124 is inserted into circuit card slot 120, bus connector (not shown) on circuit card slot 120 may become electrically and mechanically coupled to bus connector (not shown) on circuit card 124. When these bus connectors are so coupled to each other, logic 130 in circuit card 124 may become electrically coupled to bus 106. When logic 130 is electrically coupled to bus 106, processor 102 may exchange data and/or commands with logic 130 via bus 106 that may permit processor 102 to control and/or monitor the operation of logic 130.

Logic 130 may be comprised on or within any part of system 100 (e.g., motherboard 118 and/or circuit card 124). Logic 130 may comprise hardware, software, or a combination of hardware and software (e.g., firmware). For example, logic 130 may comprise circuitry (i.e., one or more circuits), to perform operations described herein. For example, logic 130 may comprise one or more digital circuits, one or more analog circuits, one or more state machines, programmable logic, and/or one or more ASICs (Application-Specific Integrated Circuits). Logic 130 may be hardwired to perform the one or more operations. Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of system 100, including network device 126, chipset 108, processor 102, and/or on motherboard 118. Logic 130 may be used to perform various functions by various components as described herein.

System 100 may comprise more than one, and other types of memories, buses, processors, and network devices. Processor 102, memory 104, and busses 106, 110, 112 may be comprised in a single circuit board, such as, for example, a system motherboard 118, but embodiments of the invention are not limited in this respect.

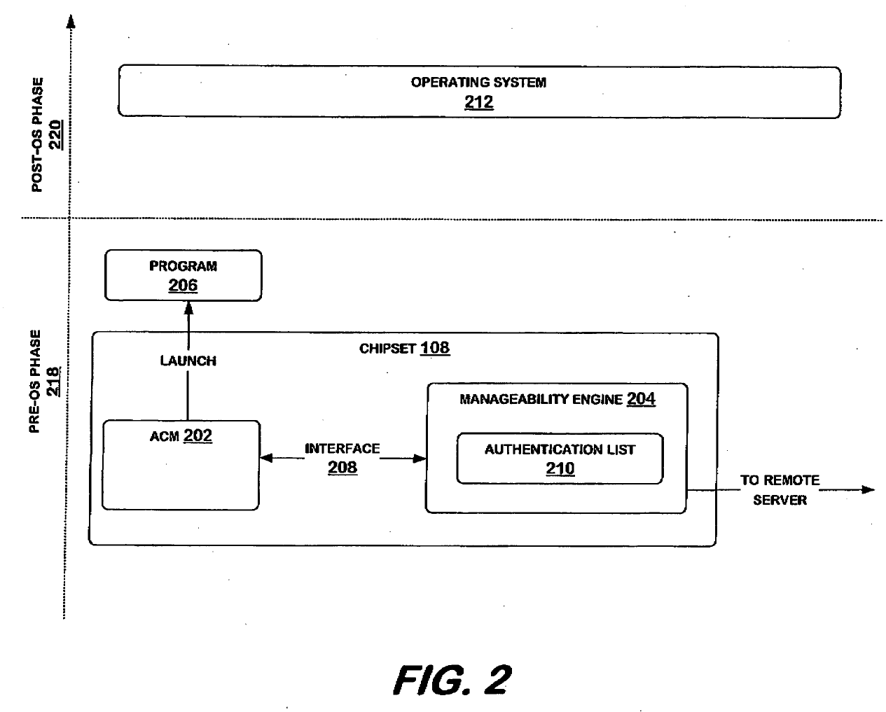

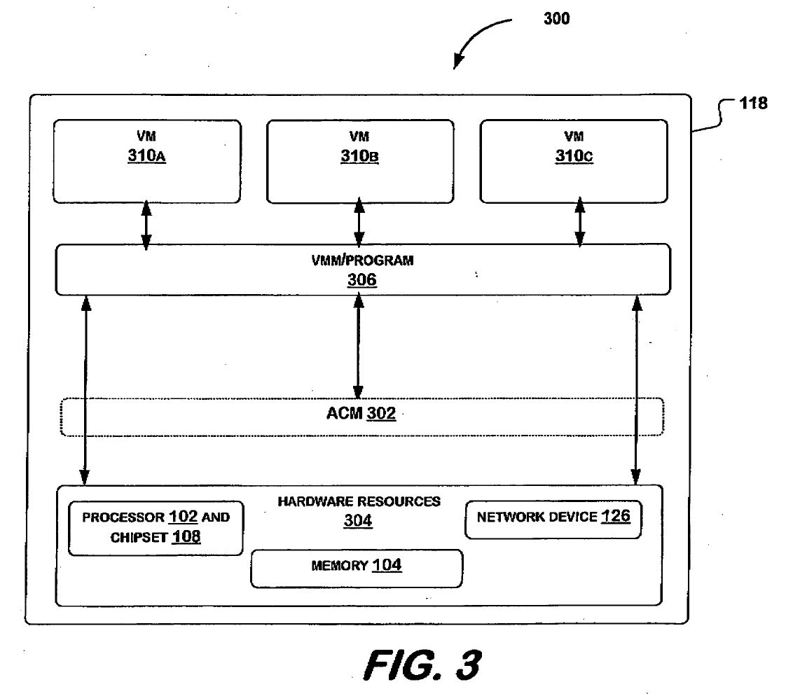

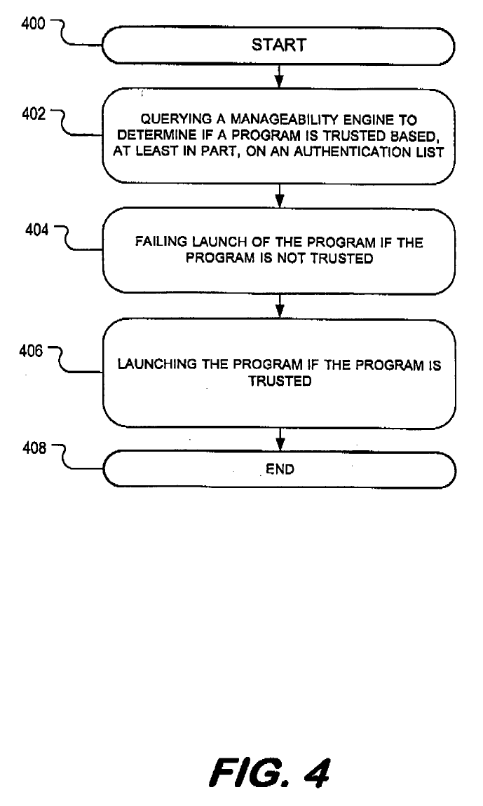

FIGS. 2 and 3 illustrate a system according to an embodiment, and FIG. 4 illustrates a method according to one embodiment of the invention. The method of FIG. 4 begins at block 400 and continues to block 402 where the method may comprise querying a manageability engine to determine if a program is trusted based, at least in part, on an authentication list.

In an embodiment, as illustrated in FIG. 2, ACM 202 (authenticated code module) may query manageability engine 204 to determine if program 206 is trusted based, at least in part, on authentication list 210. ACM refers to a module that has authenticated code, or code that is known to be trusted. In an embodiment, ACM 202 may check the state of system 100. For example, ACM 202 may check for various chipset 108 and processor 102 configurations and ensure that system 100 has an acceptable configuration (e.g., memory state). ACM 202 may be loaded into a private memory, such as a memory within processor 102 (processor memory not shown), by processor 102, and may be authenticated by processor 102 prior to being executed. In an embodiment, ACM 202 is part of Intel® Corporation's LaGrande Technology as described in LaGrande Technology Preliminary Architecture Specification, September 2006 available from Intel® Corporation (Document Number 315168 002).

Manageability engine 204 may comprise, for example, a microcontroller or a microprocessor, which may be located within chipset 108, although embodiments of the invention are not limited in this respect. In an embodiment, manageability engine 204 may enable manageability functions to be performed on a system, such as system 100. Manageability functions may comprise, for example, software updates/upgrades, running system diagnostics, and asset management. In an embodiment, manageability engine 204 may communicate with remote server 134, independently of network device's 126 ability to communicate with remote server 134, regardless of the state of the operating system (e.g., running, in a reduced power state, or disabled due to system crash or disabled power state). This is known as out-of-band manageability. In an embodiment, manageability engine 204 may enable Intel® Active Management Technology (AMT) (available from Intel® Corporation) functionality on system 100.

In an embodiment, as illustrated in FIG. 3, program 206 may comprise VMM 306 (virtual machine monitor). VMM 306 comprises software that imposes a virtualization layer so that hardware resources 110 may be virtualized into virtual machines 310A, 310B, 310C. VMM 306 may act as a host for virtual machines 310A, 310B, 310C, and may have full control of hardware resources 306. VMM 306 operates in the space where the operating system would normally be, and the operating system operates in the application space. As an example, VMM 306 is provided in Intel® Virutalization Technology (Intel® VT). Intel® VT provides hardware support for VMM that allows multiple operating systems and applications to execute in independent partitions on a single machine. In Intel® VT, VMM 306 may comprise an MVMM (measured virtual machine monitor) that is essentially the same as VMM 306, but has increased protection. In an embodiment, Intel® LaGrande Technology incorporates Intel® VT.

An authentication list, such as authentication list 210, refers to an authentication policy. An authentication policy may comprise, for example, a list of programs that may be maintained in a table, or programmed into chipset 108, for example, or other policy on which ACM 202 can rely to launch or fail launch of program 206. For example, a policy may include failing to launch programs that have a specific extension. In an embodiment, authentication list 210 may comprise a list of trusted programs (“whitelist”). Alternatively, authentication list 210 may comprise a list of malware, or other undesirable programs (“blacklist”). For example, an authentication list may comprise a list of hashes of programs. However, embodiments of the invention are not limited in this respect, and may instead comprise, for example, a list of digitally signed programs. Authentication list 210 may be stored locally, such as within a memory accessible by or via manageability engine 204. Furthermore, authentication list 210 may be updated by remote server 134. For example, remote server 134 may periodically send updated list of, for example, hashes to manageability engine 204, and manageability engine 204 may update authentication list 210 locally. Alternatively, authentication list 210 may be stored remotely, and manageability engine 204 may request authentication list 210 as needed via remote server 134. Other alternatives are possible.

ACM 202 may communicate with manageability engine 204 via an interface 208. In an embodiment, interface 208 may comprise a trusted interface 208. For example, trusted interface 208 may provide hardware and software resources to enable private communications between manageability engine 204 and ACM 202. These resources may include, for example, configuration spaces, buffers, registers, and dedicated memories. In an embodiment, trusted interface 208 may be placed in a private address space that has special access requirements, where the private address space is asserted after ACM 202 is launched. In this manner, when manageability engine 204 receives a query via trusted interface 208, manageability engine 204 knows the query is from ACM 202 (since a non-ACM module cannot launch trusted interface 208), and may respond without additional verification requirements.

Alternatively, interface 208 may comprise a public interface such as, for example, an indexed data/address port where ACM 202 and manageability engine 204 could use a cryptographic binding. An example of this is Keyboard Controller Style (KCS), which is described in, for example, the IPMI (Intelligent Platform Management Interface) Specification Second Generation, v2.0, Document Revision 1.0, Feb. 12, 2004.

In an embodiment, ACM 202 may execute in a pre-operating system phase 218. Pre-operating system phase 218 comprises a period during or after system initialization, but prior to operating system 212 being loaded during post-operating system phase 220. In pre-operating system phase 218, programs, such as hyperviruses that may disguise themselves as a VMM, may be prevented from launching by verifying that program 206 is trusted.

At block 404, the method may comprise failing launch of the program if the program is not trusted. Referring to FIG. 2, if authentication list 210 comprises a whitelist, and program 206 is not on authentication list 210 (or does not otherwise comply with a policy of authentication list 210, for example), then program 206 will fail to launch. Alternatively, if authentication list 210 comprises a blacklist, and program 206 is on authentication list 210 (or does not otherwise comply with a policy of authentication list 210, for example), then program 206 will fail to launch. In an embodiment, as illustrated in FIG. 3, program 306 will fail to launch if it does not appear on a whitelist authentication list 210, or alternatively, if it does appear on a blacklist authentication list 210.

At block 406, the method may comprise launching the program if the program is trusted. Referring to FIG. 2, if authentication list 210 comprises a blacklist, and program 206 is not on authentication list 210 (or complies with a policy of authentication list 210, for example), then program 206 will launch. Alternatively, if authentication list 210 comprises a whitelist, and program 206 is on authentication list 210 (or complies with a policy of authentication list 210, for example), then program 206 will launch. In an embodiment, as illustrated in FIG. 3, VMM 306 will launch if it does not appear on a blacklist authentication list 210, or alternatively, if it appears on a whitelist authentication list 210.

The method may end at block 408.

### CONCLUSION

Therefore, in an embodiment, a method may comprise querying a manageability engine to determine if the program is trusted based, at least in part, on an authentication list, failing launch of the program if the program is not trusted, and launching the program if the program is trusted.

In one embodiments of the invention, a method to avoid malware is described. By using a manageability engine to determine if a program is trusted, a local authentication list may be updated when needed. Alternatively, the authentication list may be remotely stored, and the manageability engine may call out to remote server to determine if a program is trusted. In an embodiment, an authenticated code module (ACM) may initiate the query to a manageability engine. Since ACM runs in a pre-operating system environment, malware, such as hyperviruses, may be avoided.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
querying a manageability engine to determine if a program is trusted based, at least in part, on an authentication list;
failing launch of the program if the program is not trusted; and
launching the program if the program is trusted.

2. The method of claim 1, wherein said querying is performed during a pre-operating system phase.

3. The method of claim 1, wherein said querying the manageability engine comprises querying the manageability engine using a trusted interface.

4. The method of claim 3, wherein the program may comprise a virtual machine monitor (VMM).

5. The method of claim 1, wherein the authentication list comprises a list of hashes of trusted programs.

6. An apparatus comprising:
logic to:
query a manageability engine to determine if the program is trusted based, at least in part, on an authentication list;
fail launch of the program if the program is not trusted; and
launch the program if the program is trusted

7. The apparatus of claim 6, wherein said logic to query comprises logic to perform the query during a pre-operating system phase.

8. The apparatus of claim 6, wherein said logic to query the manageability engine comprises logic to query the manageability engine using a trusted interface.

9. The apparatus of claim 8, wherein the program may comprise a virtual machine monitor (VMM).

10. The apparatus of claim 6, wherein the authentication list comprises a list of hashes of trusted programs.

11. A system comprising:
a manageability engine;
an indexed data/address port interface coupled to the manageability engine; and
an authenticated code module coupled to the indexed data/address port interface operable of:
query a manageability engine to determine if the program is trusted based, at least in part, on an authentication list;
fail launch of the program if the program is not trusted; and launch the program if the program is trusted.

12. The system of claim 11, wherein said logic to query comprises logic to perform the query during a pre-operating system phase.

13. The system of claim 11, wherein said logic to query the manageability engine comprises logic to query the manageability engine using a trusted interface.

14. The system of claim 13, wherein the program may comprise a virtual machine monitor (VMM).

15. The system of claim 11, wherein the authentication list comprises a list of hashes of trusted programs.

16. An article of manufacture having stored thereon instructions, the instructions when executed by a machine, result in the following:
querying a manageability engine to determine if the program is trusted based, at least in part, on an authentication list;
failing launch of the program if the program is not trusted; and
launching the program if the program is trusted.

17. The article of claim 16, wherein said instructions that result in querying comprises instructions that result in performing the query during a pre-operating system phase.

18. The article of claim 16, wherein said instructions that result in querying the manageability engine comprises instructions that result in querying the manageability engine using a trusted interface.

19. The article of claim 17, wherein the program may comprise a virtual machine monitor (VMM).

20. The article of claim 16, wherein the authentication list comprises a list of hashes of trusted programs.
